(19) United States
(12) Patent Application Publication
(10) Pub. No.: US 2025/0301412 A1
(43) Pub. Date: Sep. 25, 2025

(54) NETWORK ASSISTED PL-RS MAINTENANCE FOR INTER CELL SCENARIOS

(71) Applicant: Nokia Technologies Oy, Espoo (FI)

(72) Inventors: Daejung YOON, Nozay (FR); Lars DALSGAARD, Oulu (FI); Tero HENTTONEN, Espoo (FI); Timo KOSKELA, Oulu (FI); Sami-Jukka HAKOLA, Oulu (FI)

(21) Appl. No.: 18/863,128

(22) PCT Filed: Apr. 24, 2023
(86) PCT No.: PCT/IB2023/054190

§ 371 Date: Nov. 5, 2024

Related U.S. Application Data
(60) Provisional application No. 63/364,315, filed on May 6, 2022.

(51) Int. Cl. H04W 52/24; H04B 17/309; H04W 52/14

(52) U.S. Cl. CPC H04W 52/242; H04B 17/347; H04W 52/146

(57) ABSTRACT

Techniques to execute UL TCI switching without latency due to pathloss measurements for a list of active TCI states for UL transmission. Pathloss measurement reference signals for UL transmission are maintained to obtain power control value prior to the UL transmission to a network node. In addition, the active TCI list for UL configuration should be aligned between network and the UE by pre-configuration. A UE should prepare the pathloss measurement based on the list of active TCIs. In some implementations, the UE provides feedback to the network as to which UL TCI states it is currently maintaining, either based on network request or when UE is no longer able to maintain the PL-RS for a particular UL TCI state (i.e., the DL signal for the PL-RS is too weak to be detectable). This report could be provided for example via L1 feedback, UL MAC CE or as RRC message.

### TECHNICAL FIELD

This description relates to telecommunications systems.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, e.g., above 6 GHz. For fifth generation wireless systems (5G), an access architecture for deployment of cellular radio equipment employing mmWave radio spectrum has been proposed. Other example spectrums may also be used, such as cmWave radio spectrum (e.g., 3-30 GHz).

### SUMMARY

According to an example implementation, a method includes receiving, by a user device in a wireless network from a network node of a plurality of network nodes in the wireless network, a message indicating a set of active transmission configuration indicator (TCI) states for uplink transmission within a pool of downlink, uplink or joint transmission configuration indicator states. The method also associating, by the user device, each active transmission configuration indicator state of the plurality of active downlink or uplink transmission configuration indicator states with another network node within the plurality of network nodes; and wherein for each active uplink transmission configuration indicator state of the plurality of active uplink transmission configuration indicator states associated with the another network node, the method further comprises performing, by the user device, a pathloss measurement to obtain a power control (PC) value prior to a subsequent uplink transmission to at least one or a combination of the network node the another network node and additional network nodes from the plurality of network.

According to an example implementation, an apparatus includes at least one processor and at least one memory including computer program code, the at least one memory and the computer program code configured to, with the at least one processor, cause the apparatus at least to receive, by a user device in a wireless network from a network node of a plurality of network nodes in the wireless network, a message indicating a set of active transmission configuration indicator (TCI) states for uplink transmission within a pool of downlink, uplink or joint transmission configuration indicator states; for each active transmission configuration indicator state of the plurality of active downlink or uplink transmission configuration indicator states associated with a respective network node of the plurality of network nodes, associate, by the user device, each active transmission configuration indicator state of the plurality of active downlink or uplink transmission configuration indicator states with another network node within the plurality of network nodes; and wherein for each active uplink transmission configuration indicator state of the plurality of active uplink transmission configuration indicator states associated with the another network node, the at least one memory and the computer program code are further configured to cause the apparatus at least to perform, by the user device, a pathloss measurement to obtain a power control (PC) value prior to a subsequent uplink transmission to at least one or a combination of the network node, the another network node and additional network nodes from the plurality of network nodes.

According to an example implementation, an apparatus includes means for receiving, by a user device in a wireless network from a network node of a plurality of network nodes in the wireless network, a message indicating a set of active transmission configuration indicator (TCI) states for uplink transmission within a pool of downlink, uplink or joint transmission configuration indicator states. The apparatus also means for associating, by the user device, each active transmission configuration indicator state of the plurality of active downlink or uplink transmission configuration indicator states with another network node within the plurality of network nodes; and wherein for each active uplink transmission configuration indicator state of the plurality of active uplink transmission configuration indicator states associated with the another network node, the apparatus further includes means for performing, by the user device, a pathloss measurement to obtain a power control (PC) value prior to a subsequent uplink transmission to at least one or a combination of the network node the another network node and additional network nodes from the plurality of network.

According to an example implementation, a computer program product includes a computer-readable storage medium and storing executable code that, when executed by at least one data processing apparatus, is configured to cause the at least one data processing apparatus to receive, by a user device in a wireless network from a network node of a plurality of network nodes in the wireless network, a message indicating a set of active transmission configuration indicator (TCI) states for uplink transmission within a pool of downlink, uplink or joint transmission configuration indicator states; for each active transmission configuration indicator state of the plurality of active downlink or uplink transmission configuration indicator states associated with a respective network node of the plurality of network nodes, associate, by the user device, each active transmission configuration indicator state of the plurality of active downlink or uplink transmission configuration indicator states with another network node within the plurality of network nodes; and wherein for each active uplink transmission configuration indicator state of the plurality of active uplink transmission configuration indicator states associated with the another network node, the at least one memory and the computer program code are further configured to cause the apparatus at least to perform, by the user device, a pathloss measurement to obtain a power control (PC) value prior to a subsequent uplink transmission to at least one or a combination of the network node, the another network node and additional network nodes from the plurality of network nodes.

According to an example implementation, a method includes transmitting, by a network node of a plurality of network nodes in a wireless network to a user device served by the serving network node, a message indicating a set of active uplink transmission configuration indicator (TCI) states for uplink transmission within a pool of downlink, uplink, or joint transmission configuration indicator states; wherein each active transmission configuration indicator state of the plurality of active downlink or uplink transmission configuration indicator states are associated with another network node within the plurality of network nodes. The method also includes, wherein for each active uplink transmission configuration indicator state of the plurality of active uplink transmission configuration indicator states associated with the another network node, the method further comprises receiving an uplink transmission from the user device at a power based on a power control (PC) value obtained from a pathloss measurement performed by the user device prior to the user device transmitting the uplink transmission.

According to an example implementation, an apparatus includes at least one processor and at least one memory including computer program code, the at least one memory and the computer program code configured to, with the at least one processor, cause the apparatus at least to transmit, by a network node of a plurality of network nodes in a wireless network to a user device served by the serving network node, a message indicating a set of active uplink transmission configuration indicator (TCI) states for uplink transmission within a pool of downlink, uplink, or joint transmission configuration indicator states; wherein each active transmission configuration indicator state of the plurality of active downlink or uplink transmission configuration indicator states are associated with another network node within the plurality of network nodes; and wherein for each active uplink transmission configuration indicator state of the plurality of active uplink transmission configuration indicator states associated with the another network node, the at least one memory and the computer program code are further configured to cause the apparatus at least to receive an uplink transmission from the user device at a power based on a power control (PC) value obtained from a pathloss measurement performed by the user device prior to the user device transmitting the uplink transmission.

According to an example implementation, an apparatus includes means for transmitting, by a network node of a plurality of network nodes in a wireless network to a user device served by the serving network node, a message indicating a set of active uplink transmission configuration indicator (TCI) states for uplink transmission within a pool of downlink, uplink, or joint transmission configuration indicator states; wherein each active transmission configuration indicator state of the plurality of active downlink or uplink transmission configuration indicator states are associated with another network node within the plurality of network nodes. The apparatus also includes means for, wherein for each active uplink transmission configuration indicator state of the plurality of active uplink transmission configuration indicator states associated with the another network node, the method further comprises receiving an uplink transmission from the user device at a power based on a power control (PC) value obtained from a pathloss measurement performed by the user device prior to the user device transmitting the uplink transmission.

According to an example implementation, a computer program product includes a computer-readable storage medium and storing executable code that, when executed by at least one data processing apparatus, is configured to transmit, by a network node of a plurality of network nodes in a wireless network to a user device served by the serving network node, a message indicating a set of active uplink transmission configuration indicator (TCI) states for uplink transmission within a pool of downlink, uplink, or joint transmission configuration indicator states; wherein each active transmission configuration indicator state of the plurality of active downlink or uplink transmission configuration indicator states are associated with another network node within the plurality of network nodes; and wherein for each active uplink transmission configuration indicator state of the plurality of active uplink transmission configuration indicator states associated with the another network node, the at least one memory and the computer program code are further configured to cause the apparatus at least to receive an uplink transmission from the user device at a power based on a power control (PC) value obtained from a pathloss measurement performed by the user device prior to the user device transmitting the uplink transmission.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a digital communications network according to an example implementation.

FIG. 2 is a diagram illustrating a unified transmission configuration indicator (TCI) state activation and deactivation via a media access control element (MAC CE).

FIG. 3A is a diagram illustrating an aspect of the claimed improvement in which active uplink (UL) TCI states are reused from active downlink (DL) TCI states, according to an example implementation.

FIG. 3B is a diagram illustrating an aspect of the claimed improvement in which active UL TCI states are set independently of active DL TCI states, according to an example implementation.

FIG. 3C is a diagram illustrating an aspect of the claimed improvement in which active UL TCI states are a subset of an active DL and UL TCI list with a pathloss reference signal (PL-RS) maintenance indication, according to an example implementation.

FIG. 4 is a diagram illustrating an aspect of the claimed improvement in which a set of active TCI states is indicated up to UE capability by a network node, according to an example implementation.

FIG. 5 is a signalling diagram further illustrating the aspect of the claimed improvement in which active UL TCI states are reused from active downlink (DL) TCI states, according to an example implementation.

FIG. 6 is a signalling diagram further illustrating the aspect of the claimed improvement in which active UL TCI states are set independently of active DL TCI states, according to an example implementation.

FIG. 7 is a signalling diagram further illustrating the aspect of the claimed improvement in which pathloss reference signals in UL TCI state are separately indicated by a network node for pathloss reference signal maintenance, according to an example implementation.

FIG. 8 is a signalling diagram further illustrating an aspect of the claimed improvement in which a user device (UE) selects or releases PL-RS measurements according to a PL-RS measurement status report, according to an example implementation.

FIG. 9 is a flow chart illustrating a process of setting active UL TCI states with time or frequency tracking and power control values for UL transmission to a network node based on pathloss measurements, according to an example implementation.

FIG. 10 is a flow chart illustrating a process of scheduling UL transmission from a UE using active UL TCI states of which pathloss measurements are maintained by the UE, according to an example implementation.

FIG. 11 is a block diagram of a node or wireless station (e.g., base station/access point, relay node, or mobile station/user device) according to an example implementation.

### DETAILED DESCRIPTION

The principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

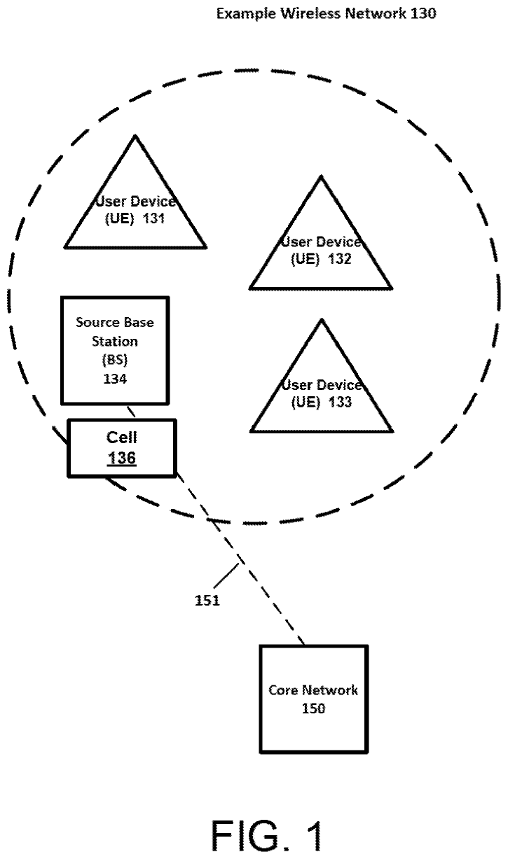

FIG. 1 is a block diagram of a digital communications system such as a wireless network 130 according to an example implementation. In the wireless network 130 of FIG. 1, user devices 131, 132, and 133, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e) Node B (eNB) may also be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network 150 via an interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/serving cell change of user devices between BSs, one or more gateways that may forward data and control signals between the BSs and packet data networks or the Internet, and other control functions or blocks.

The various example implementations may be applied to a wide variety of wireless technologies, wireless networks, such as LTE, LTE-A, 5G (New Radio, or NR), cmWave, and/or mmWave band networks, or any other wireless network or use case. LTE, 5G, cmWave and mmWave band networks are provided only as illustrative examples, and the various example implementations may be applied to any wireless technology/wireless network. The various example implementations may also be applied to a variety of different applications, services or use cases, such as, for example, ultra-reliability low latency communications (URLLC), Internet of Things (IoT), time-sensitive communications (TSC), enhanced mobile broadband (eMBB), massive machine type communications (MMTC), vehicle-to-vehicle (V2V), vehicle-to-device, etc. Each of these use cases, or types of UEs, may have its own set of requirements.

It is widely assumed that path-loss maintenance is a condition of ‘active’ transmission configuration indicator (TCI) states for uplink (UL) transmission. In fact, there is no discernable definition of ‘active’ TCI for UL or related behaviors in the current RAN1 and RAN2 spec yet. In contrast, active downlink (DL) TCI definition and behaviors are known.

For DL or UL medium access control element (MAC-CE) and downlink control information (DCI) switching, an active TCI state list may be used to trigger TCI switching for DL or UL. If a TCI state is active, the user device/equipment (UE) is configured to conduct time or frequency tracking on the source reference signal (RS). Such DL MAC-CE active state has been defined. A comparison of DL and UL switching statements as currently captured follows.

If the target TCI state is unknown, upon receiving physical downlink shared channel (PDSCH) carrying a MAC-CE activation command in slot n, a UE should be able to receive a UE-dedicated physical downlink control channel (PDCCH)/PDSCH with a target TCI state of the serving cell on which TCI state switch occurs at the first slot that is after slot n+T_{HARQ}+3Nₛₗₒₜ^{subframe,μ}+T_{L1-RSRP}+TOᵤₖ*(T_{first-SSB}+T_{SSB-proc})/(NR slot length).

For separate UL TCI state switch or joint TCI state switch for physical uplink control channel (PUCCH) or physical uplink shared channel (PUSCH), or semi-persistent/aperiodic/periodic sounding reference signal (SRS), when beamCorrespondenceWithoutUL-BeamSweeping is set to 1, upon receiving PDSCH carrying MAC-CE activation command in slot n on a serving cell.
If target TCI state is known
   The UE should be able to transmit uplink signal with the target TCI state in the slot n+T_{HARQ}+3 ms+NM*(T_{first_target-PL-RS}+4*T_{target_PL-RS}+2 ms).
If target TCI state is unknown
   The UE shall be able to transmit uplink signal with the target TCI state in the slot n+T_{HARQ}+3 ms+T_{L1-RSRP}+T_{first_target-PL-RS}+4*T_{target_PL-RS}+2 ms.
      where NM=1, if the target PL-RS is not maintained by the UE, and NM=0 otherwise.

TCI switching commend can be given as separate TCI for DL or UL respectively, or can be also given as a joint TCI state that consists of a set of DL and UL TCI states. A UE manages active TCI states for UL that can be indicated by a separate UL TCI or a UL TCI contained in a joint TCI.

A problem currently lie with the active TCI state for UL. For example, the UE behavior may not be clear enough regarding how a UE may manage active UL TCI or active joint TCI comparing to the existing active DL TCI. For DL case, if the target TCI state is in the active TCI state list for PDSCH/PDCCH, the UE may track time or frequency sync on the resource RS. When DL TCI is indicated, the UE may immediately demodulate the PDCCH/PDSCH based on the sync information. In RAN1 and RAN2, when the DL case clearly specifies maxNumberActiveTCI-PerBWP in tci-statePDSCH, a UE should track time or frequency sync. In another example, multiple Joint TCI (DL/UL) states or multiple separate DL or UL TCIs are possible in the unified TCI frame work, up to 8 active TCI states may be activated, but only 4 PL-RS can be maintained based on the current spec. There is mismatch between the number of active TCI states and the number of maintained PL-RSs.

For UL transmission, RAN4 has mainly discussed about path-loss measurement. Nevertheless, a fundamental condition for active UL TCI may still have been missed: for example, a UE should keep time or frequency sync to the source RS for UL transmission. A UE may not be able to transmit PUCCH/PUSCH/SRS independently from a DL sync. The maxNumberActiveTCI-PerBWP may refer to activated TCI-states per BWP per carrier component (CC) with UE synchronization for DL and UL.

It may be understood that a fundamental condition for an active TCI for UL may be missing: there may be no condition specified for an active TCI list for UL switching in the current specs. A UE should keep time or frequency sync to the source RS (SRS) in the UL TCI to be capable of UL transmission.

As mentioned, an active UL TCI state may have more conditions than an active DL TCI state. In fact, the active UL TCI state with PL-RS measurement maintenance is not defined in any of RAN1/2 spec. RAN1/2 has only active TCI state for tci-statePDSCH, and up to eight active TCI states can be configured based on UE capability. Moreover, a UE may not expect to maintain more than four pathloss estimates per serving cell for all PUSCH/PUCCH/SRS transmissions.

It may be assumed that some of active TCI state for DL may be reused for active TCI states for UL, e.g., there may be four active UL TCI states that are a subset of the eight active DL TCI states. In some implementations, however, some have assumed that at least one of the four active UL TCI states may not be included in the eight active DL TCI states. It is noted that the number of UL and DL TCI states mentioned are merely an example and does not limit the number of active UL and DL TCI states.

Assuming that maintained pathloss reference signal (PL-RS) is an active UL TCI condition, there are at least three issues:
The network may have insufficient information regarding which PL-RS is maintained by the UE, so the network does not know which UL TCI state associated with PL-RS is available for UL transmission. PL-RS maintenance remains as UE selection, that becomes critical in UL scheduling by the network.
A UE may have insufficient information regarding which TCI(s) of the 8 active TCI state list may be used for UL transmission. A UE also may have insufficient information regarding which PL-RS should be maintained.
If PL-RS is not maintained among the eight active TCI states by a UE, the network cannot schedule UL transmission immediately, or network experiences UL switching latency due to PL-RS five-sample measurement delay.

A PL-RS measurement is a pre-condition to achieve UL transmission, but it is not clear if the five-sample of PL-RS period is essential for pathloss measurement. For example, in DCI-based UL TCI switching, this activation of UL TCI may be quicker than MAC-CE based switching. In CR DCI-based TCI switching, it is unclear if the active TCI list in DL TCI state switching is the same TCI list equal to the active TCI list in UL TCI state and, moreover, what should be the UE behaviors regarding the active UL TCI state. The active TCI list may seem different between the DL and UL cases because of PL-RS maintenance in UL.

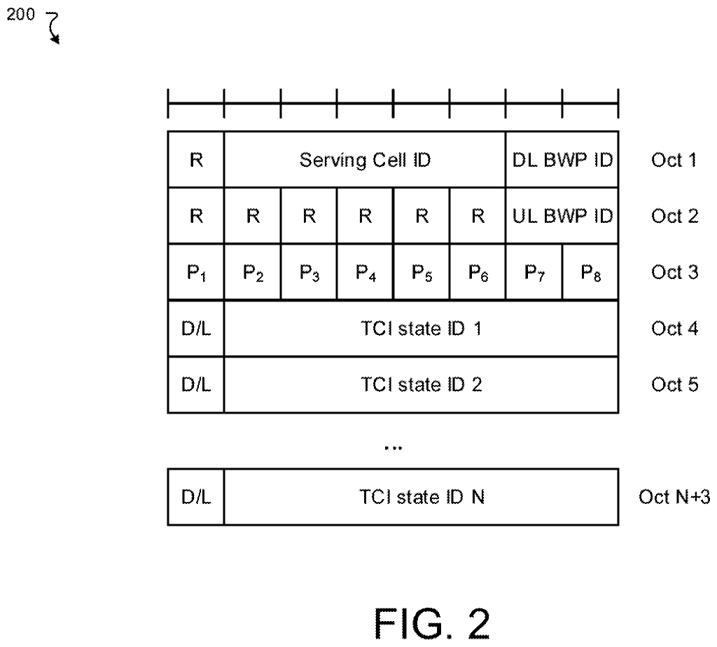

FIG. 2 is a diagram illustrating a unified TCI state activation and deactivation 200 via a MAC-CE. The Unified TCI States Activation/Deactivation MAC CE is identified by a MAC subheader with extended Logical Channel Identifier (eLCID), an identifier used to identify the MAC CE. It may have a variable size consisting of following fields:
Serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4; this MAC CE applies to all the serving cells in the set simultaneousU-TCI-UpdateList1, simultaneousU-TCI-UpdateList2, simultaneousU-TCI-UpdateList3 or simultaneousU-TCI-UpdateList4, respectively;
DL BWP ID: This field indicates a DL BWP for which the MAC CE applies as the codepoint of the DCI bandwidth part indicator field. The length of the DL BWP ID field is 2 bits;
UL BWP ID: This field indicates a UL BWP for which the MAC CE applies as the codepoint of the DCI bandwidth part indicator field. The length of the UL BWP ID field is 2 bits;
Pi field: This field indicates whether each TCI codepoint has multiple TCI states or single TCI state. If the Pi field is set to 1, it may indicate that the i^{th} TCI codepoint includes the DL TCI state and the UL TCI state. If the Pi field is set to 0, it may indicate that the i^{th} TCI codepoint includes only the DL TCI state or the UL TCI state;
D/U: This field indicates whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId. If D/U is set to 1, 7-bits length TCI state ID i.e., TCI-StateId. If D/U is set to 0, the most significant bit of TCI state ID is considered as the reserved bit and remainder 6 bits indicate the UL-TCIState-Id. In an example, the maximum number of activated TCI states may be 16;
R: Reserved bit, set to 0.

Another of technical problems is how to execute UL TCI switching without latency due to pathloss measurements. If the pathloss measurement is not ready in a previous stage of UL transmission triggering, it may be inevitable to allow more time for its measurements, however it is not desirable for network operation. Alternatively, a reasonable solution is to set an active TCI list for UL. This may be a list of active TCIs for which UE maintains readiness for TCI switching. In addition, the active TCI list for UL configuration may be aligned between network and the UE by pre-configuration. A UE should prepare the pathloss measurement based on the list of active TCIs. In some implementations, the UE may provide feedback to the network as to which pathloss reference signals in UL TCI states is currently under maintaining, either based on a network request or when the UE is no longer able to maintain the PL-RS for a particular UL TCI state (i.e., the DL signal for the PL-RS is too weak to be detectable). This report may be provided for example via anyone of: a layer 1 (L1) feedback, a UL MAC CE or a RRC message.

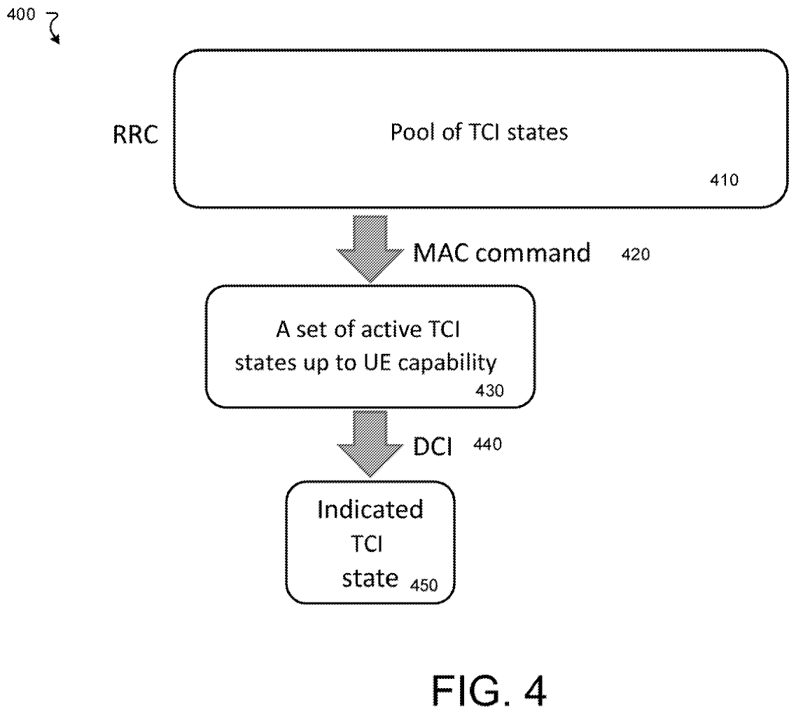

This is illustrated in process 400 shown in FIG. 4. At 410, the UE is sent the pool of TCI states via RRC signalling. At 430, the UE receives via MAC command 420 up to eight activated states. At 450, the UE receives an indicated TCI state via DCI 440.

For a particular UL TCI state, the network may configure active UL TCI configuration beyond current maximum limit to four, but maintained PL-RS capability of the UE to less than four, which the UE may not be expected to maintain more than four pathloss estimates per serving cell for all PUSCH/PUCCH/SRS transmissions, although more number of PL-RSs in the active UL TCI are configured for the UE. When the PL-RS in UL TCI is not maintained, additional time of (T_{first_target-PL-RS}+4*T_{target_PL-RS}+2 ms) may be required to execute PL-RS measurement as:
If target TCI state is known
   The UE should be able to transmit uplink signal with the target TCI state in the slot n+T_{HARQ}+3 ms+NM*(T_{first_target-PL-RS}+4*T_{target_PL-RS}+2 ms).
If target TCI state is unknown
   The UE shall be able to transmit uplink signal with the target TCI state in the slot n+T_{HARQ}+3 ms+T_{L1-RSRP}+T_{first_target-PL-RS}+4*T_{target_PL-RS}+2 ms.
      where NM=1, if the target PL-RS is not maintained by the UE, and NM=0 otherwise.

Accordingly, the condition that “PL-RS is maintained” may mean that pathloss measurement status is completed using M samples of the PL-RS. Thus, the UE and has determined a power control (PC) value for UL transmission, where:

M samples are determined by measurement scenario.

In this disclosure, it may be asserted that a maintained PL-RS is a necessary condition for “an active TCI list for UL”, of which some feature aspects may be described with the following examples.

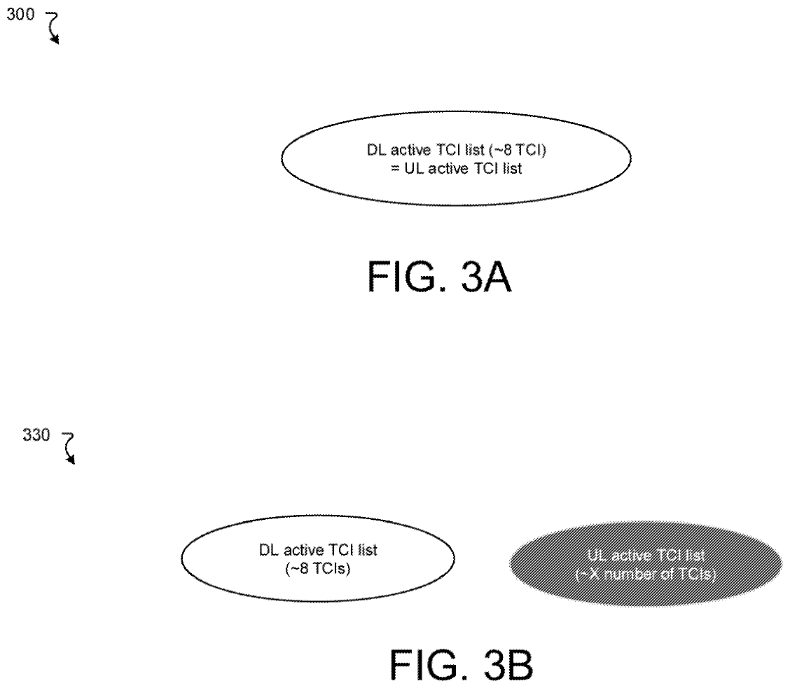

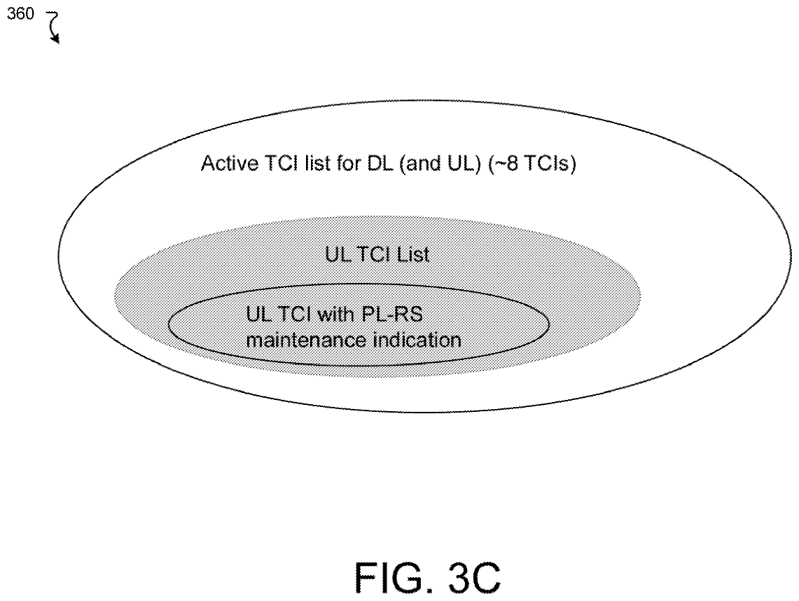

A first aspect for enabling active TCI list for UL is to reuse the legacy active TCI list. The active UL TCI list refers to the legacy active TCI list, that also means reusing the active DL TCI list for UL. This aspect is illustrated as 300 in FIG. 3A.

FIG. 4 is a diagram illustrating an aspect of the claimed improvement in which a set of active UL TCI state beyond a current maximum is indicated by a network node, according to an example implementation.

In this case, a number of maintained PL-RS may be up to a maximum of eight from a current allowed maximum of four PL-RSs. A UE may thus track time or frequency sync tracking for DL and UL behaviors, and up to eight PL-RS associated with a resource RS in UL TCI may be maintained if it is indicated in the active TCI list. In this way, the network may trigger any UL transmission immediately without delay using the active UL TCI list. In some implementations, an active UL TCI list for PL-RS may be defined which is a subset of a full active UL TCI list. There may be certain rules for how the UE may determine the active UL TCI list for the PL RS. For example:
UL TCI may be in the full active UL TCI list, and/or
UL TCI may be among the lowest N (e.g., 4) activated UL TCI (ID generated in MAC), and/or
at least one UL TCI may be having a source RS of a serving cell and one other UL TCI state having a source RS of a non-serving cell.

In some alternate implementations, the gNB, when activating UL TCI states, may separately indicate which PL-RS in the UL TCI states (up to N, N=4 up to Rel-16) which the UE should maintain in terms of path loss measurements.

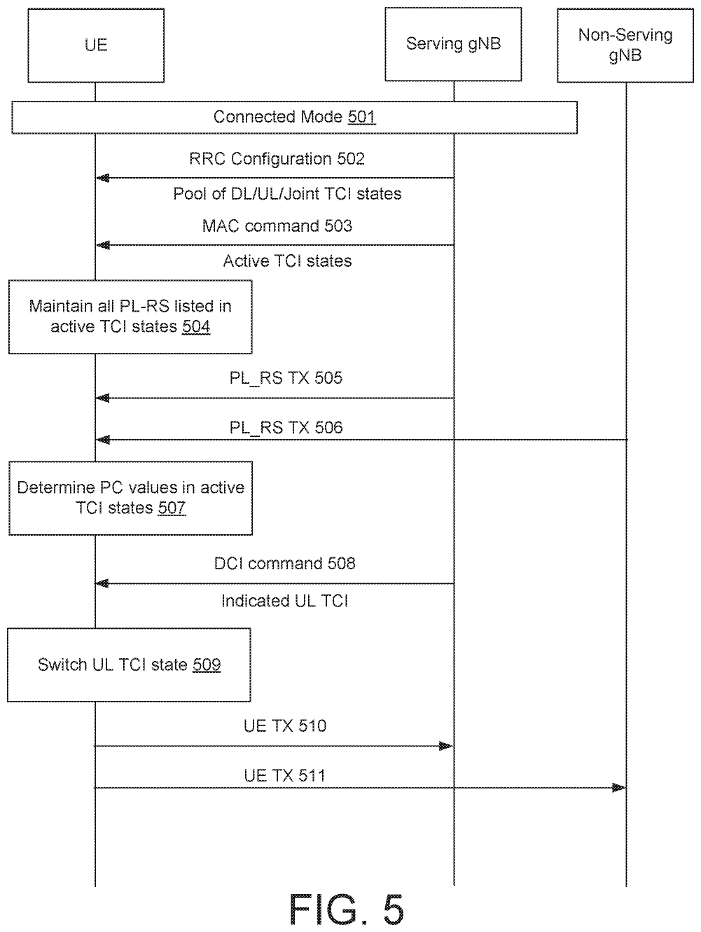

FIG. 5 is a signalling diagram further illustrating the first aspect, as shown in FIG. 3B.

At 501, the UE and the serving gNB are in a CONNECTED mode.

At 502, the serving gNB transmits a radio resource control (RRC) configuration including a pool of DL/UL/Joint TCI states.

At 503, the serving gNB transmits a MAC command including a list of active TCI states.

At 504, the UE maintains all PL-RSs listed in the active TCI states.

At 505 and 506, the serving gNB and a non-serving gNB each transmits an identifier of PL-RSs to maintain the PL-RS.

At 507, the UE determines power control (PC) values in the active TCI states.

At 508, the serving gNB transmits a DCI command indicating a target UL TCI state.

At 509, the UE switches the UL TCI state to the target UL TCI state.

At 510 and 511, the UE sends a UL transmission to the serving and non-serving gNBs using the respective power control value measured based on PL-RS indicated by UL TCI.

A second aspect for enabling active TCI list for UL is to set a separate active UL TCI list independently from the DL TCI list. This independent TCI list may still allow some or fully overlapped TCI states between the DL TCI list and the UL TCI list. This is illustrated as 330 in FIG. 3B.

This aspect introduces active UL TCI state list indication up to X number of TCI. First, the UE capability needs to indicate its active UL TCI state capability as tci-StatePUCCH or tci-StatePUSCH or tci-State_PUSCCH_PUSCH.
maxNumberActiveTCIforUL-PerBWP indicates the maximum number of activated UL TCI-states per BWP per carrier component (CC), including control and data. If a UE reports X active TCI state(s), it is not expected that more than X active QCL type D assumption(s) for any PUSCH or PUCCH for a given BWP of a serving cell become active for the UE. The UE shall include this field.
The UE may track and maintain pathloss reference signal in the active TCI states.

The network refers to the UE capability and can separately update the active UL TCI list for UL transmission by RRC signaling, e.g., as per following (new field emphasized):

Alternative 1: Indication within UL TCI state configuration

| | |
|---|---|
| UL-TCIState-r17 ::= | SEQUENCE { |
| ul-TCIState-Id-r17 | UL-TCIState-Id-r17, |
| servingCellId-r17 | ServCellIndex |

OPTIONAL, -- Need

[symbol]

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | PUCCH-SRS |

},

| | |
|---|---|
| additionalPCI-r17 | AdditionalPCIIndex-r17 |

OPTIONAL, --

[symbol]

| | |
|---|---|
| ul-powerControl-r17 | Uplink-powerControlId-r17 |

OPTIONAL, --

[symbol]

| | |
|---|---|
| pathlossReferenceRS-Id-r17 | PUSCH-PathlossReferenceRS-Id |

OPTIONAL, --

[symbol]

| | |
|---|---|
| activeTCI-ForPLRS-r17 | ENUMERATED {true} |

[symbol]

indicates data missing or illegible when filed

Alternative 2: List of active UL TCI states (e.g.,
in BWP-UplinkDedicated or ServingCellConfig)

| | |
|---|---|
| activeUL-TCI-ForPLRS-List | SEQUENCE (SIZE (1..maxULTCI-r17)) OF |

UL-TCIState-Id-r17

This includes UL TCIs configured in separate TCI and joint TCI configuration in Rel-17 feMIMO.

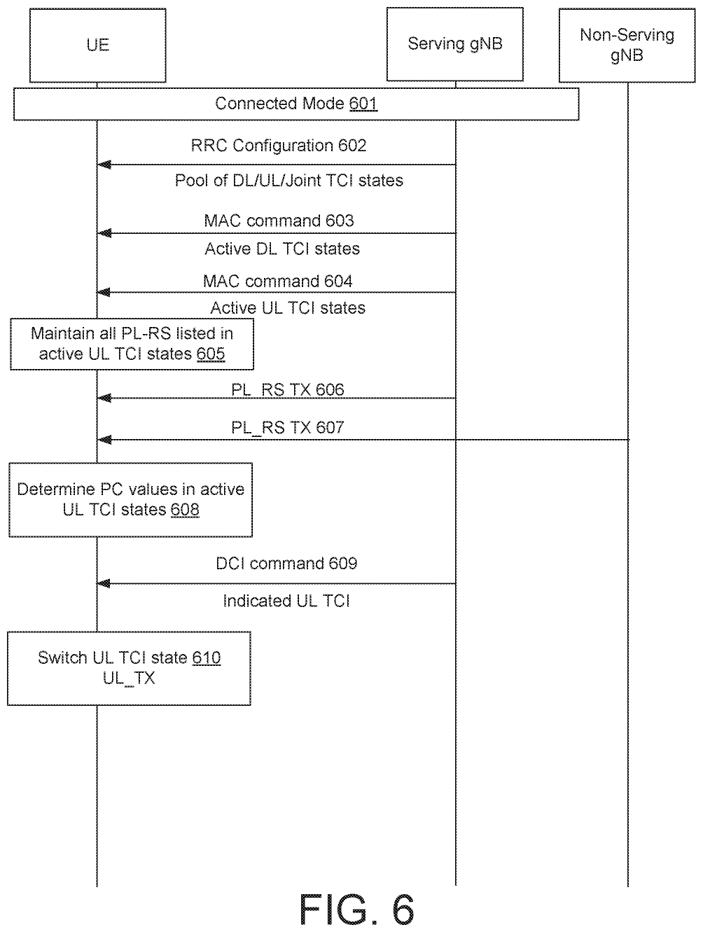

FIG. 6 is a signalling diagram further illustrating the second aspect, as shown in FIG. 3C.

At 601, the UE and the serving gNB are in a CONNECTED mode.

At 602, the serving gNB transmits a radio resource control (RRC) configuration including a pool of DL/UL/Joint TCI states.

At 603, the serving gNB transmits a MAC command including a list of active DL TCI states.

At 604, the serving gNB transmits a MAC command including a list of active UL TCI states.

At 605, the UE maintains all PL-RSs listed in the active TCI states.

At 606 and 607, the serving gNB and a non-serving gNB transmit an identifier of PL-RSs to maintain the PL-RS.

At 608, the UE determines power control (PC) values in the active TCI states.

At 609, the serving gNB transmits a DCI command indicating a target UL TCI state.

At 610, the UE switches the UL TCI state to the target UL TCI state and transmits a signal with power according to the PC value for the target UL TCI state.

A third aspect for enabling active TCI list for UL is to introduce PL-RS maintenance indication for the active UL TCI. This is illustrated as 360 in FIG. 3C. Active TCI list for DL exists. FIG. 3C shows that active UL TCI list refers to active DL TCI list. Among them, PL-RS maintenance is separately indicated.

A UE can track up to eight active TCI states. Accordingly, the network configures UL TCIs by referring to the source RS in the DL TCI, i.e., the source RS in DL and UL TCIs are same. Then the network can separately configure PL-RS maintenance indication by RRC or by MAC. Thus, a UE may only maintain the PL-RS indicated by the network rather than not all of the PL-RS in UL TCIs. In fact, because the UE cost of PL-RS measurement may be expensive, the UE can save measurement resources by maintaining essential PL-RS via network indication.

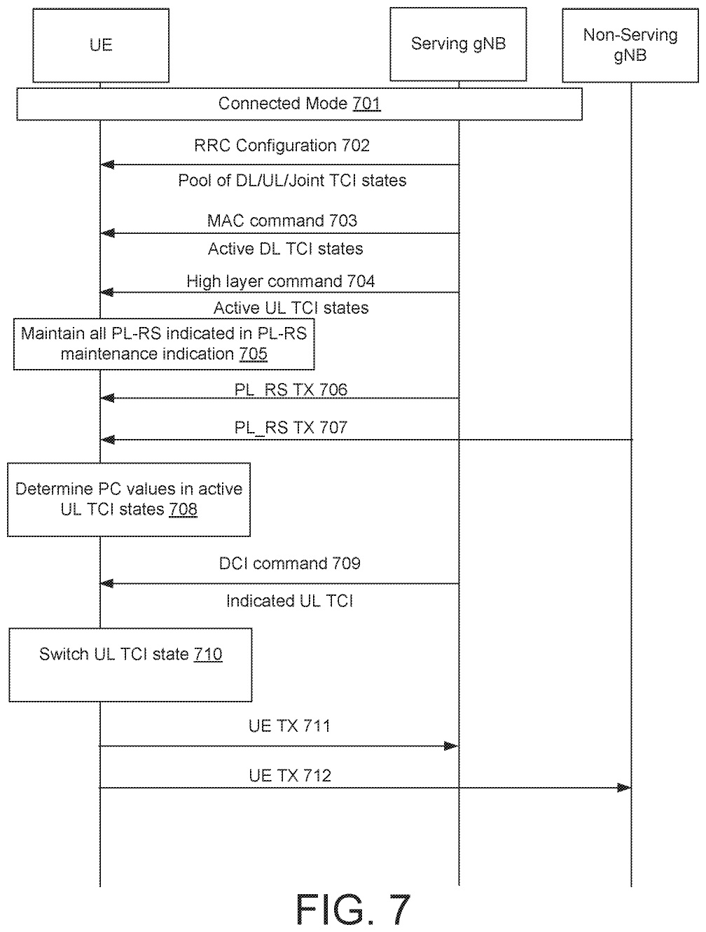

FIG. 7 is a signalling diagram further illustrating the third aspect.

At 701, the UE and the serving gNB are in a CONNECTED mode.

At 702, the serving gNB transmits a radio resource control (RRC) configuration including a pool of DL/UL/Joint TCI states.

At 703, the serving gNB transmits a MAC command including a list of active DL TCI states.

At 704, the serving gNB transmits a high layer command including a list of active UL TCI states.

At 705, the UE maintains all PL-RSs listed in the active TCI states.

At 706 and 707, the serving gNB and a non-serving gNB transmit an identifier of PL-RSs to maintain.

At 708, the UE determines power control (PC) values in the active TCI states.

At 709, the serving gNB transmits a DCI command indicating a target UL TCI state.

At 710, the UE switches the UL TCI state to the target UL TCI state.

At 711 and 712, the UE sends a UL transmission to the serving and non-serving gNBs according to the respective PC value for the target TCI state.

In some implementations, the PL-RS that the network assumes UE to maintain may be indicated in a MAC-CE (downlink MAC-CE). The MAC-CE may include a N-bit bitmap wherein fields in the bitmap correspond to the active TCI State IDs listed in the MAC-CE that is used to activate (unified) TCI states (e.g., the TCI states may be one or more of: DL or Joint TCI states and/or UL TCI states). The DL or Joint TCI State may refer to a TCI state that applies the (indicated) TCI state for downlink channel(s) or (jointly for) both uplink and downlink channel(s). UL TCI state may refer to a TCI state for UL channel(s). As an example, the DL/UL channels may refer to PDCCH/PDSCH/PUSCH/PUCCH.
As an example, the first field in the bitmap may correspond to the first TCI State ID in a MAC that is used for activating (unified) TCI states
In general there is a known mapping for the bitfield and TCI State IDs (i.e., there may be a one to one mapping of bitfields and TCI state IDs in a MAC CE used to activate TCI state(s)).
As an example, if eight TCI States are activated, the bitfield may have valid fields up to eight entries.
As another example, if only four TCI states are activated, the bitfield may have valid fields only up to four entries. The remainder may be ignored by the UE.
TCI states may be joint DL/UL TCI States, DL TCI states (e.g., DL or Joint TCI states) or UL TCI states.
In some implementations, when the UE is configured to maintain PL estimates according to (separate) PL RS maintenance indication MAC CE, the UE is required only to maintain PL RS estimate for the PL RS that are indicated in the MAC CE.
In the MAC CE, one value in the bit field (e.g., ‘1’) indicates that PL estimate is expected to be maintained for the corresponding RS/TCI state. Another value (e.g., ‘0’) implies that the PL is not required to be maintained for the corresponding RS.
In one example, the PL RS indication (e.g., the bitmap) may be a part of the MAC CE used for activating the TCI State IDs (e.g., A MAC CE format for Unified TCI States Activation/Deactivation). Each bit field in the bitmap corresponds to one TCI State ID. A new MAC CE ID (LCID identifying a MAC CE may be used for the format including the PLRS indication. In another example, a bit field may be associated with each of the activated TCI states in a MAC CE used for activating the (unified) TCI state IDs, wherein the bit field indicates whether the (pathloss) RS indicated by the TCI state is configured to be used for maintaining the path loss estimate. The bit field may comprise of one or more bits. The one or bits, may indicate at least one value indicating that a particular TCI state ID (the RS indicated by the TCI state) may be used for maintaining a pathloss estimate.

In some implementations, the PL RS that network assumes UE to maintain may be indicated in an RRC message. The RRC message may contain the RS index list for which UE is assumed to maintain PL estimate.
Alternatively, the RRC message may have a list of K entries (e.g., K is a number of total PL-RS configurations which may be up to 64 or 128 etc.) for PL-RS, and the network may further use MAC CE to select up to N number of PL-RS configurations (N is a UE capability representing how many PL-RS configuration can be measured by the UE). In one example the list may comprise of SSBs that may be associated with the serving cell (serving cell PCI e.g., PCI #X) and/or one or more PCI(s) different from the serving cell (e.g., PCI #Y, PCI #Z).
The MAC CE may have a bitmap (up to K bits length). Each field corresponds to one entry in the associated RRC PL RS list. One value in the bit field (e.g., ‘1’) indicates that PL RS is expected to be maintained for the corresponding PL RS.

In some implementations, if the network has activated an UL TCI state that indicates RS (SSB or channel state information reference signal (CSI-RS)) which is configured for L1-RSRP reporting. The UE may maintain a pathloss estimate for the RS, if the RS is a synchronization signal block (SSB) or for the quasi-colocation (QCL) source SSB of the CSI-RS.
If the UE is expected to maintain pathloss estimate for the UL/joint TCI (based on the source RS or the configured pathloss RS), it may perform the TCI state change to the indicated UL/joint TCI state according to the maintained PL RS requirements (e.g., less delay is expected for the TCI state switch if the path loss is assumed to be maintained vs. not expected to be maintained).
If the UE is not expected to maintain pathloss estimate for the UL/joint TCI (based on the source RS, or the configured pathloss RS), it may perform the TCI state change to the indicated UL/joint TCI state with delay expected for completing the PL RS measurement.

In some implementations, the UE selects up to N pathloss RSs for path loss estimation that correspond to the RS (QCL source RS or QCL source of the source up to the SSB) configured for L1-RSRP reporting. For example, if a TCI state indicates a pathloss RS (or an RS that is assumed to be used for pathloss reference) that is a SSB #N (SSB index N) and same SSB may be configured for L1-RSRP reporting, UE may be configured to select such RS for the pathloss estimation. In some implementations, the UE may provide feedback to the network when the UE may no longer be able to maintain the PL-RS for a particular UL/joint TCI state.
If the number of selected PL RS exceeds the UE maximum value, the UE may select or release the PL RS for pathloss measurement(s) according to the ascending index of the active TCI State ID as signaling in a MAC CE activating the (unified) TCI States (e.g., Unified TCI States Activation/Deactivation MAC CE).

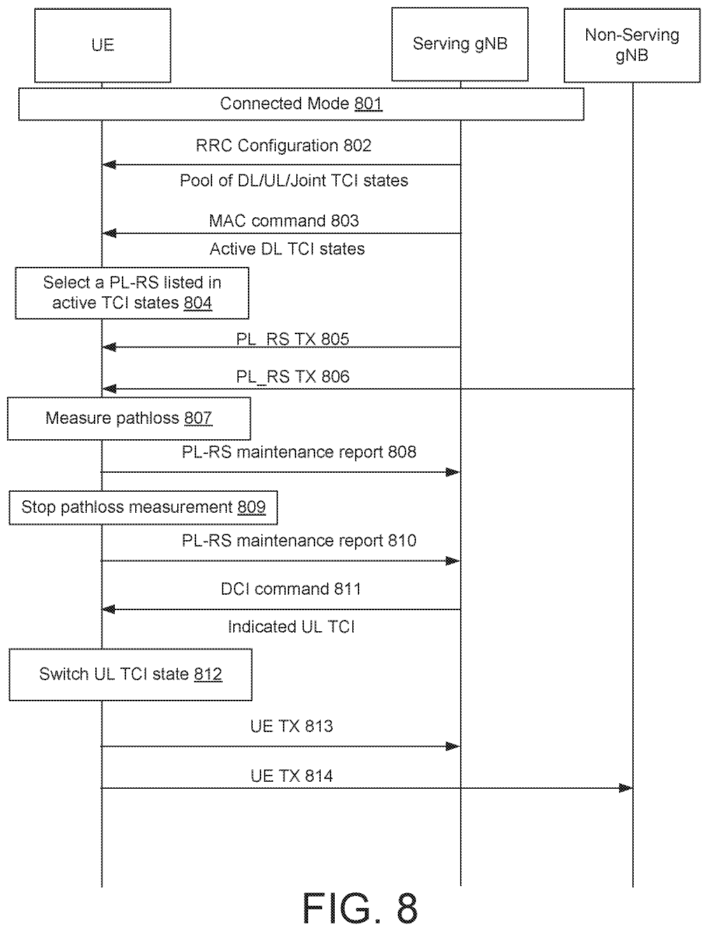

FIG. 8 is a signalling diagram to further illustrate a fourth aspect based on the above-described implementations.

At 801, the UE and the serving gNB are in a CONNECTED mode.

At 802, the serving gNB transmits a radio resource control (RRC) configuration including a pool of DL/UL/Joint TCI states.

At 803, the serving gNB transmits a MAC command including a list of active DL TCI states.

At 804, the UE selects a PL-RS listed in the active TCI states.

At 805 and 806, the serving gNB and a non-serving gNB transmit an identifier of PL-RSs.

At 807, the UE performs a pathloss measurement.

At 808, the UE transmits a PL-RS maintenance report to the serving gNB.

At 809, the UE halts the pathloss measurement.

At 810, the UE transmits a PL-RS maintenance report to the serving gNB.

At 811, the serving gNB transmits a DCI command indicating a target UL TCI state.

At 813, the UE switches the UL TCI state to the target UL TCI state.

At 813 and 8, the UE sends a UL transmission to the serving and non-serving gNBs according to the respective PC value for the target TCI state.

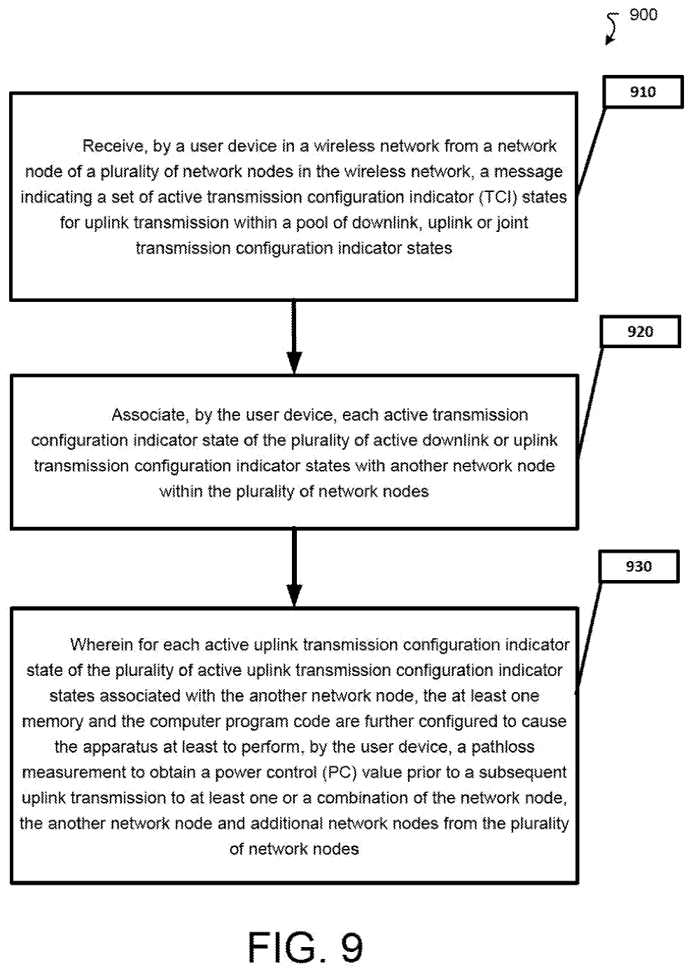

Example 1-1: FIG. 9 is a flow chart illustrating a process 900 of determining action to take upon execution of a machine learning algorithm. Operation 910 includes receiving, by a user device in a wireless network from a network node of a plurality of network nodes in the wireless network, a message indicating a set of active transmission configuration indicator (TCI) states for uplink transmission within a pool of downlink, uplink or joint transmission configuration indicator states. Operation 920 includes associating, by the user device, each active transmission configuration indicator state of the plurality of active downlink or uplink transmission configuration indicator states with another network node within the plurality of network nodes. Operation 930 includes, wherein for each active uplink transmission configuration indicator state of the plurality of active uplink transmission configuration indicator states associated with the another network node, the method further comprises performing, by the user device, a pathloss measurement to obtain a power control (PC) value prior to a subsequent uplink transmission to at least one or a combination of the network node the another network node and additional network nodes from the plurality of network.

Example 1-2: According to an example implementation of Example 1-1, further comprising performing, by the user device, time or frequency synchronization prior to downlink reception from or uplink transmission to the network node.

Example 1-3: According to an example implementation of Example 1-2, further comprising receiving, from the network node, a request to switch to a target active uplink transmission configuration indicator state of the plurality of active uplink transmission configuration indicator states; and transmitting a signal to the network node of the plurality of network nodes at a power based on the power control value obtained prior to an uplink transmission for the network node.

Example 1-4: According to an example implementation of Example 1-3, further comprising receiving an uplink transmission configuration indicator command through separate transmission configuration indicator for uplink, or receive the uplink transmission configuration indicator command through a joint transmission configuration indicator that consists of a set of downlink and uplink transmission configuration indicator.

Example 1-5: According to an example implementation of Examples 1-1 to 1-4, each of the plurality of transmission configuration indicator states include respective quasi-colocation information (QCI) indicating a source reference signal (RS) for a respective network node of the plurality of network nodes.

Example 1-6: According to an example implementation of Examples 1-1 to 1-5, wherein the plurality of active uplink transmission configuration indicator states is based on a plurality of active downlink transmission configuration indicator states.

Example 1-7: According to an example implementation of Example 1-1, wherein a plurality of active uplink transmission configuration indicator states is a subset of a pool of transmission configuration indicator states for downlink and uplink; and wherein the method further comprises receiving a message from a network node which pathloss measurement of one or more pathloss reference signal in the uplink transmission configuration states is performed.

Example 1-8: According to an example implementation of Example 1-7, wherein the plurality of active downlink transmission configuration indicator states are being reused for the plurality of active uplink transmission configuration indicator states.

Example 1-9: According to an example implementation of Examples 1-7 to 1-8, wherein a number of active uplink transmission configuration indicator states is a prespecified number; and wherein the method further comprises receiving, from a network node, a message indicating a set of uplink transmission configuration indicator states of the pool of uplink transmission configuration indicator states to activate, the set of uplink transmission configuration indicator states to activate having the prespecified number of uplink transmission configuration indicator states.

Example 1-10: According to an example implementation of Examples 1-1 to 1-9, wherein the plurality of active uplink transmission configuration indicator states is mutually or partially exclusive of a plurality of active downlink transmission configuration indicator states; and wherein the method further comprises receiving a message from the network node at which pathloss measurement of one or more pathloss reference signal in the uplink transmission configuration states has been performed.

Example 1-11: According to an example implementation of Examples 1-9 to 1-10: wherein the message is one of a radio resource control message or a media access control element message.

Example 1-12: According to an example implementation of Examples 1-3 to 1-11, further comprising receiving, by the user device from the network node, a message indicating a set of active uplink transmission configuration indicator states of a pool of uplink transmission configuration indicator states, each of the plurality of active uplink transmission configuration indicator states including respective quasi-colocation information indicating a source reference signal for a respective network node of the plurality of network nodes; selecting up to a specified number of pathloss reference signals in the active uplink transmission configuration indicator states for path loss measurement; and transmitting a pathloss measurement status on the selected pathloss reference signal to the network node independent of whether a user device maintains pathloss reference signal in the active uplink transmission configuration indicator states.

Example 1-13: An apparatus comprising means for performing a method of any of Examples 1-1 to 1-12.

Example 1-14: A computer program product including a non-transitory computer-readable storage medium and storing executable code that, when executed by at least one data processing apparatus, is configured to cause the at least one data processing apparatus to perform a method of any of Examples 1-1 to 1-12.

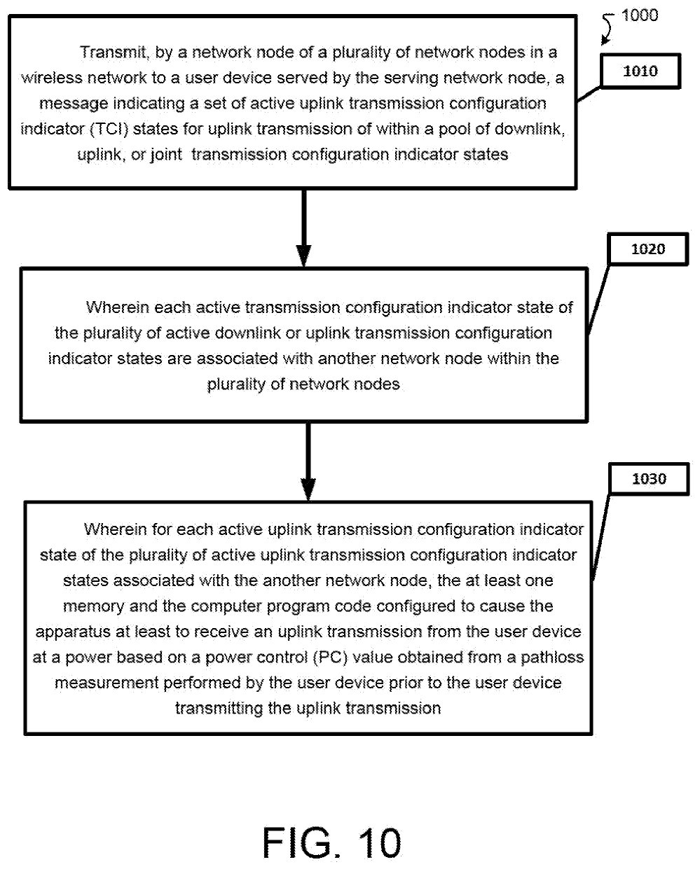

Example 2-1: FIG. 10 is a flow chart illustrating a process 1000 of determining action to take upon execution of a machine learning algorithm. Operation 1010 includes transmitting, by a network node of a plurality of network nodes in a wireless network to a user device served by the serving network node, a message indicating a set of active uplink transmission configuration indicator (TCI) states for uplink transmission within a pool of downlink, uplink, or joint transmission configuration indicator states. Operation 1020 includes, wherein each active transmission configuration indicator state of the plurality of active downlink or uplink transmission configuration indicator states are associated with another network node within the plurality of network nodes. Operation 1030 includes, wherein for each active uplink transmission configuration indicator state of the plurality of active uplink transmission configuration indicator states associated with the another network node, the method further comprises receiving an uplink transmission from the user device at a power based on a power control (PC) value obtained from a pathloss measurement performed by the user device prior to the user device transmitting the uplink transmission.

Example 2-2: According to an example implementation of Example 2-1, wherein time or frequency synchronization is performed by the user device, prior to prior to the user device's uplink transmission to or downlink reception from the network node.

Example 2-3: According to an example implementation of Example 2-2, further comprising transmitting, to the user device, a request to switch to a target active uplink transmission configuration indicator state of the plurality of active uplink transmission configuration indicator states, wherein a signal is received the network node at a power based on the power control value.

Example 2-4: According to an example implementation of Example 2-3, further comprising transmitting an uplink transmission configuration indicator command through separate transmission configuration indicator for the user device's uplink or transmit the user device's uplink transmission configuration indicator command through a joint transmission configuration indicator that consists of a set of the user device's downlink and uplink transmission configuration indicators.

Example 2-5: According to an example implementation of Examples 2-1 to 2-4: wherein each of the plurality of transmission configuration indicator states including respective quasi-colocation information (QCI) indicating a source reference signal (RS) for a respective network node of the plurality of network nodes.

Example 2-6: According to an example implementation of Examples 2-1 to 2-5, wherein the plurality of active uplink transmission configuration indicator states is based on a plurality of active downlink transmission configuration indicator states.

Example 2-7: According to an example implementation of Example 2-6, wherein the plurality of active downlink transmission configuration indicator states are being reused for the plurality of active uplink transmission configuration indicator states.

Example 2-8: According to an example implementation of Examples 2-6 to 2-7, wherein a number of active uplink transmission configuration indicator states is a prespecified number; and wherein the method further comprises transmitting, to the user device, a message indicating a set of uplink transmission configuration indicator states of the pool of uplink transmission configuration indicator states to activate, the set of uplink transmission configuration indicator states to activate having the prespecified number of uplink transmission configuration indicator states.

Example 2-9: According to an example implementation of Examples 2-1 to 2-7, wherein the plurality of active uplink transmission configuration indicator states is mutually or partially exclusive of a plurality of active downlink transmission configuration indicator states; and wherein the method further comprises transmitting a message to the user device having activating the plurality of uplink transmission configuration indicator states, wherein the pathloss measurements are performed in the active uplink transmission configuration indicator states prior to a subsequent uplink transmission from the user device.

Example 2-10: According to an example implementation of Examples 2-1 to 2-8, wherein each of the plurality of active uplink transmission configuration indicator states is a subset of a pool of transmission configuration indicator states for downlink and uplink; and wherein the method further comprises transmitting a message to the user device at which pathloss measurement of one or more pathloss reference signal in the uplink transmission configuration states has been performed.

Example 2-11: According to an example implementation of Examples 2-9 to 2-10, wherein the message is one of a radio resource control message or a media access control element message.

Example 2-12: According to an example implementation of Examples 2-3 to 2-11, further comprising transmitting, to the user device, a message indicating a set of active uplink transmission configuration indicator states of a pool of uplink transmission configuration indicator states, each of the plurality of active uplink transmission configuration indicator states including respective quasi-colocation information indicating a source reference signal for a respective network node of the plurality of network nodes; and receiving a pathloss measurement status on a selected pathloss reference signal to the network node independent of whether the user device maintains pathloss reference signal in the active uplink transmission configuration indicator states.

Example 2-13: An apparatus comprising means for performing a method of Examples 2-1 to 2-12.

Example 2-14: A computer program product including a non-transitory computer-readable storage medium and storing executable code that, when executed by at least one data processing apparatus, is configured to cause the at least one data processing apparatus to perform a method of Examples 2-1 to 2-12.

### List of Example Abbreviations:

RSRP Reference Signal Received Power
L1 Layer 1/Physical Layer
PCI Physical Cell Identifier
TCI Transmission Configuration Indicator
SSB Synchronization Signal Block (SS/PBCH block)
RRM Radio Resource Management
PL-RS Path loss reference signal

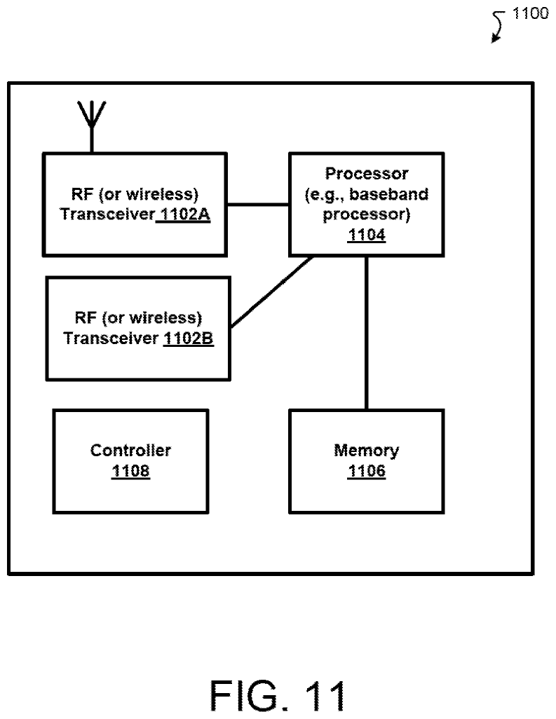

FIG. 11 is a block diagram of a wireless station (e.g., AP, BS, e/gNB, NB-IoT UE, UE or user device) 1100 according to an example implementation. The wireless station 1100 may include, for example, one or multiple RF (radio frequency) or wireless transceivers 1102A, 1102B, where each wireless transceiver includes a transmitter to transmit signals (or data) and a receiver to receive signals (or data). The wireless station also includes a processor or control unit/entity (controller) 1104 to execute instructions or software and control transmission and receptions of signals, and a memory 1106 to store data and/or instructions.

Processor 1104 may also make decisions or determinations, generate slots, subframes, packets or messages for transmission, decode received slots, subframes, packets or messages for further processing, and other tasks or functions described herein. Processor 1104, which may be a baseband processor, for example, may generate messages, packets, frames or other signals for transmission via wireless transceiver 1102 (1102A or 1102B). Processor 1104 may control transmission of signals or messages over a wireless network, and may control the reception of signals or messages, etc., via a wireless network (e.g., after being down-converted by wireless transceiver 1102, for example). Processor 1104 may be programmable and capable of executing software or other instructions stored in memory or on other computer media to perform the various tasks and functions described above, such as one or more of the tasks or methods described above. Processor 1104 may be (or may include), for example, hardware, programmable logic, a programmable processor that executes software or firmware, and/or any combination of these. Using other terminology, processor 1104 and transceiver 1102 (1102A or 1102B) together may be considered as a wireless transmitter/receiver system, for example.

In addition, referring to FIG. 11, a controller (or processor) 1108 may execute software and instructions, and may provide overall control for the station 1100, and may provide control for other systems not shown in FIG. 11 such as controlling input/output devices (e.g., display, keypad), and/or may execute software for one or more applications that may be provided on wireless station 1100, such as, for example, an email program, audio/video applications, a word processor, a Voice over IP application, or other application or software.

In addition, a storage medium may be provided that includes stored instructions, which when executed by a controller or processor may result in the processor 904, or other controller or processor, performing one or more of the functions or tasks described above.

According to another example implementation, RF or wireless transceiver(s) 1102A/1102B may receive signals or data and/or transmit or send signals or data. Processor 1104 (and possibly transceivers 1102A/1102B) may control the RF or wireless transceiver 1102A or 1102B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G uses multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall as intended in the various embodiments.

1-52. (canceled)

53. An apparatus, comprising:
at least one processor; and
at least one memory including computer program code;
the at least one memory and the computer program code configured to cause the apparatus at least to:
receive, by a user device in a wireless network from a network node of a plurality of network nodes in the wireless network, a message indicating a set of active transmission configuration indicator (TCI) states for uplink transmission within a pool of downlink, uplink or joint transmission configuration indicator states;
associate, by the user device, each active transmission configuration indicator state of the plurality of active downlink or uplink transmission configuration indicator states with another network node within the plurality of network nodes; and
wherein for each active uplink transmission configuration indicator state of the plurality of active uplink transmission configuration indicator states associated with the another network node, the at least one memory and the computer program code are further configured to cause the apparatus at least to perform, by the user device, a pathloss measurement to obtain a power control (PC) value prior to a subsequent uplink transmission to at least one or a combination of the network node, the another network node and additional network nodes from the plurality of network nodes.

54. The apparatus as in claim 53, wherein the at least one memory and the computer program code are further configured to cause the apparatus at least to:
perform, by the user device, time or frequency synchronization prior to downlink reception from or uplink transmission to the network node.

55. The apparatus as in claim 54, wherein the at least one memory and the computer program code are further configured to cause the apparatus at least to:
receive, from the network node, a request to switch to a target active uplink transmission configuration indicator state of the plurality of active uplink transmission configuration indicator states; and
transmit a signal to the network node of the plurality of network nodes at a power based on the power control value obtained prior to an uplink transmission for the network node.

56. The apparatus as in claim 55, wherein the at least one memory and the computer program code are further configured to cause the apparatus at least to:
receive an uplink transmission configuration indicator command through separate transmission configuration indicator for uplink, or receive the uplink transmission configuration indicator command through a joint transmission configuration indicator that consists of a set of downlink and uplink transmission configuration indicator.

57. The apparatus as in claim 53, wherein each of the plurality of transmission configuration indicator states including respective quasi-colocation information (QCI) indicating a source reference signal (RS) for a respective network node of the plurality of network nodes.

58. The apparatus as in claim 53, wherein the plurality of active uplink transmission configuration indicator states is based on a plurality of active downlink transmission configuration indicator states.

59. The apparatus as in claim 58, wherein the plurality of active downlink transmission configuration indicator states are being reused for the plurality of active uplink transmission configuration indicator states.

60. The apparatus as in claim 58, wherein a number of active uplink transmission configuration indicator states is a prespecified number; and
wherein the at least one memory and the computer program code are further configured to cause the apparatus at least to:
receive, from a network node, a message indicating a set of uplink transmission configuration indicator states of the pool of uplink transmission configuration indicator states to activate, the set of uplink transmission configuration indicator states to activate having the prespecified number of uplink transmission configuration indicator states.

61. The apparatus as in claim 53, wherein the plurality of active uplink transmission configuration indicator states is mutually or partially exclusive of a plurality of active downlink transmission configuration indicator states;
wherein the at least one memory and the computer program code are further configured to cause the apparatus at least to:
receive a message from the network node having activating the plurality of uplink transmission configuration indicator states; and
perform, by the user device, the pathloss measurements in the active uplink transmission configuration indicator states prior to a subsequent uplink transmission.

62. The apparatus as in claim 53, wherein each of the plurality of active uplink transmission configuration indicator states is a subset of a pool of transmission configuration indicator states for downlink and uplink; and
wherein the at least one memory and the computer program code are further configured to cause the apparatus at least to:
receive a message from the network node at which pathloss measurement of one or more pathloss reference signal in the uplink transmission configuration states has been performed.

63. The apparatus of claim 61, wherein the message is one of a radio resource control message or a media access control element message.

64. The apparatus as in claim 55, wherein the at least one memory and the computer program code are further configured to cause the apparatus at least to:
receive, by the user device from the network node, a message indicating a set of active uplink transmission configuration indicator states of a pool of uplink transmission configuration indicator states, each of the plurality of active uplink transmission configuration indicator states including respective quasi-colocation information indicating a source reference signal for a respective network node of the plurality of network nodes;
select up to a specified number of pathloss reference signals in the active uplink transmission configuration indicator states for path loss measurement; and
transmit a pathloss measurement status on the selected pathloss reference signal to the network node independent of whether a user device maintains pathloss reference signal in the active uplink transmission configuration indicator states.

65. An apparatus, comprising:
at least one processor; and
at least one memory including computer program code;
the at least one memory and the computer program code configured to cause the apparatus at least to:
transmit, by a network node of a plurality of network nodes in a wireless network to a user device served by the serving network node, a message indicating a set of active uplink transmission configuration indicator (TCI) states for uplink transmission within a pool of downlink, uplink, or joint transmission configuration indicator states;
wherein each active transmission configuration indicator state of the plurality of active downlink or uplink transmission configuration indicator states are associated with another network node within the plurality of network nodes; and
wherein for each active uplink transmission configuration indicator state of the plurality of active uplink transmission configuration indicator states associated with the another network node, the at least one memory and the computer program code configured to cause the apparatus at least to receive an uplink transmission from the user device at a power based on a power control (PC) value obtained from a pathloss measurement performed by the user device prior to the user device transmitting the uplink transmission.

66. The apparatus as in claim 65, wherein time or frequency synchronization is performed by the user device, prior to the user device's uplink transmission to or downlink reception from the network node.

67. The apparatus as in claim 66, wherein the at least one memory and the computer program code are further configured to cause the apparatus at least to:
transmit, to the user device, a request to switch to a target active uplink transmission configuration indicator state of the plurality of active uplink transmission configuration indicator states, wherein a signal is received by the network node at a power based on the power control value.

68. The apparatus as in claim 67, wherein the at least one memory and the computer program code are further configured to cause the apparatus at least to:
transmit an uplink transmission configuration indicator command through separate transmission configuration indicator for the user device's uplink, or transmit the user device's uplink transmission configuration indicator command through a joint transmission configuration indicator that consists of a set of the user device's downlink and uplink transmission configuration indicators.

69. The apparatus as in claim 65, wherein each of the plurality of transmission configuration indicator states including respective quasi-colocation information (QCI) indicating a source reference signal (RS) for a respective network node of the plurality of network nodes.

70. The apparatus as in claim 65, wherein the plurality of active uplink transmission configuration indicator states is based on a plurality of active downlink transmission configuration indicator states.

71. The apparatus as in claim 70, wherein the plurality of active downlink transmission configuration indicator states are being reused for the plurality of active uplink transmission configuration indicator states.

72. The apparatus as in claim 70, wherein a number of active uplink transmission configuration indicator states is a prespecified number; and
wherein the at least one memory and the computer program code are further configured to cause the apparatus at least to:
transmit, to the user device, a message indicating a set of uplink transmission configuration indicator states of the pool of uplink transmission configuration indicator states to activate, the set of uplink transmission configuration indicator states to activate having the prespecified number of uplink transmission configuration indicator states.
